(19) United States
(12) Patent Application Publication
(10) Pub. No.: US 2012/0132448 A1
(43) Pub. Date: May 31, 2012

(54) PLANT PACKING DEVICE AND METHOD

(76) Inventor: Ralph Costley, Locust Grove, GA (US)

(21) Appl. No.: 13/306,873

(22) Filed: Nov. 29, 2011

Related U.S. Application Data
(60) Provisional application No. 61/417,661, filed on Nov. 29, 2010.

(51) Int. Cl. A01B 1/20; A01D 7/00; A01B 1/00

(52) U.S. Cl. 172/1; 172/371; 56/400.04; 172/372

(57) ABSTRACT

The invention relates to a device for exerting a compressive force on soil around the root ball of a plant for compacting the soil. The device has a substantially planar head having a pair of arms that are configured to extend over at least a portion of the soil above the root ball of the plant for exerting a compressive force on a portion of the soil. The device also has a handle fixedly attached to the head that is configured to transfer force to the head when a user exerts a compressive force to the handle, thereby compacting soil positioned beneath the head.

### CROSS-REFERENCE TO RELATED APPLICATIONS

This application claims the benefit of United States Application No. 61/417,661, filed Nov. 29, 2010, which is hereby incorporated herein by reference in its entirety.

### FIELD OF THE INVENTION

This invention relates to a device for compacting soil. More specifically, this invention relates to a device configured to extend around and/or over a portion of the soil above a root ball of a plant for compacting the soil around the plant.

### BACKGROUND OF THE INVENTION

In order to plant a plant such as a landscaping plant or a tree in the ground, a user begins by digging a hole in the ground that is larger than the root ball of the plant and placing the root ball of the plant into the hole. Backfill soil is then placed in the hole surrounding the root ball and is at least slightly compacted. In order to compact the soil, the user typically compacts the backfill soil with his foot. This type of conventional compaction is generally less efficacious because branches or foliage from the plant can prevent the user from accessing with his foot all areas of the soil that require compacting. In addition, the surface area of a user's foot can be relatively small when compared to the area of soil to be compacted, thus requiring several compactions and repositionings of the foot. Alternatively, the user can bend over or squat down and compact the backfill soil with his hands. This can cause undue back stress, and again branches or foliage can limit access to the areas that require compacting.

Thus, there is a need in the pertinent art for devices and methods that allow a user to readily access the soil around a plant that need compacting, and does not require the user to bend all the way to the ground in order to do so. The present invention fulfills these needs and provides further related advantages as describe herein.

### DETAILED DESCRIPTION OF THE FIGURES

These and other features of the preferred embodiments of the invention will become more apparent in the detailed description in which reference is made to the appended drawings wherein:

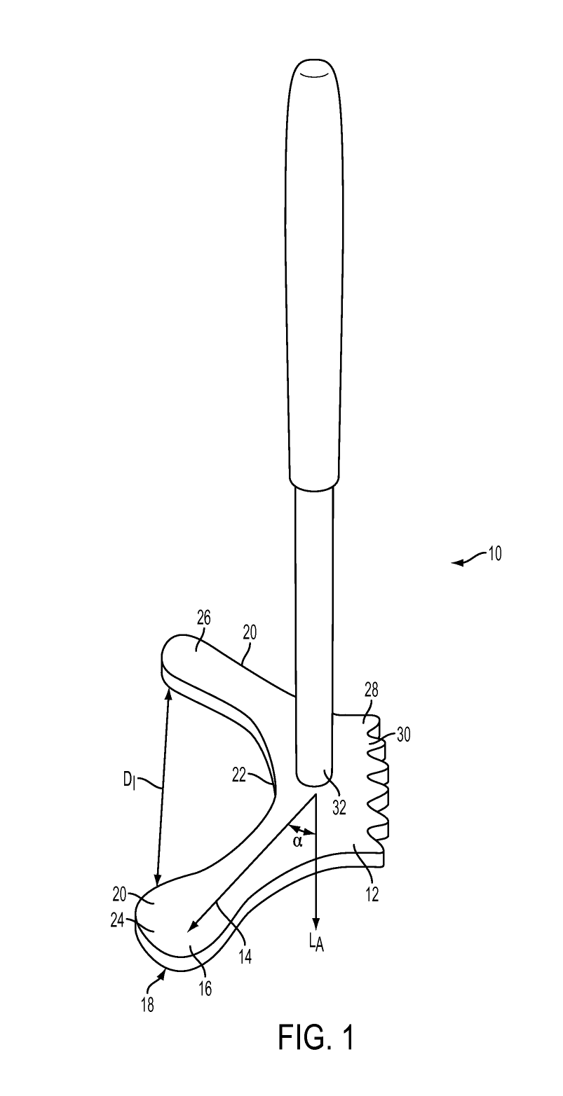

FIG. 1 is a perspective view of a device for exerting a compressive force device on the fill soil surrounding an implanted plant, according to one embodiment.

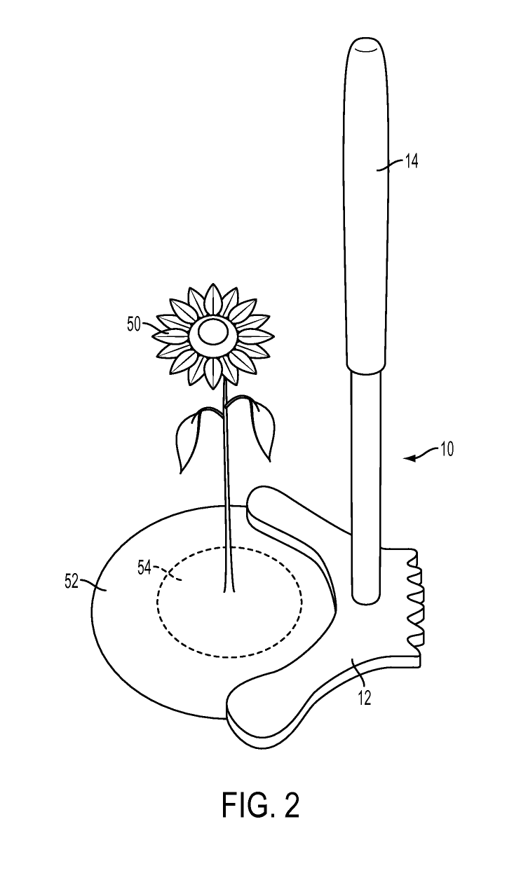

FIG. 2 is a perspective view of the device of FIG. 1 showing the device in use, according to one aspect.

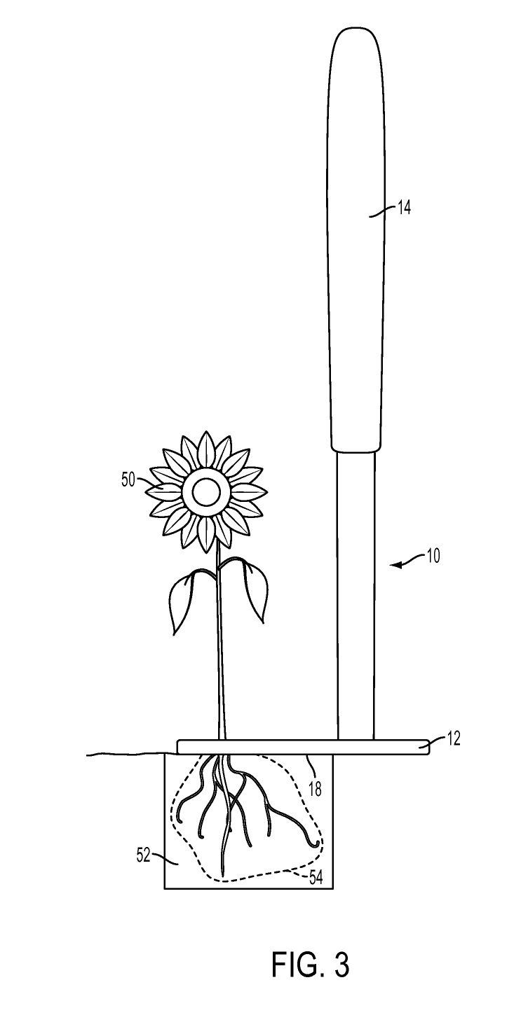

FIG. 3 is a side elevational view of the device of FIG. 1 showing the device in use, according to one aspect.

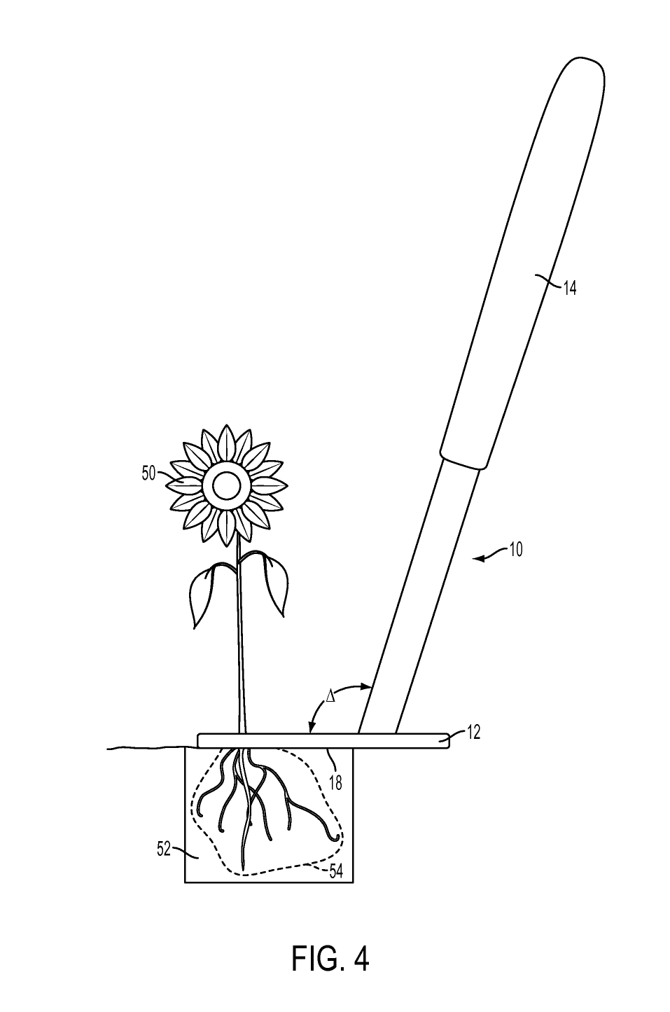

FIG. 4 is a side elevational view of the device of FIG. 1 showing the device in use, according to one aspect.

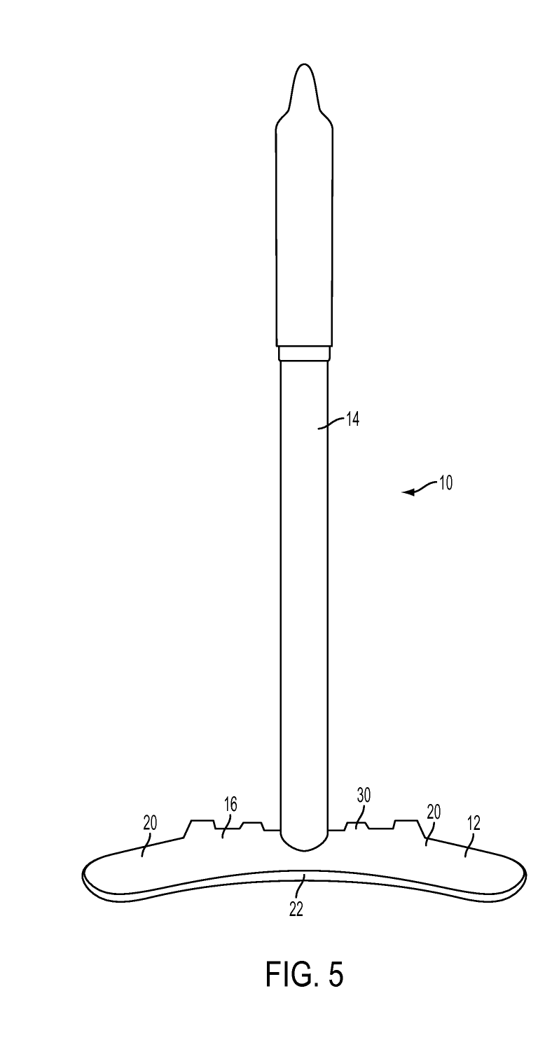

FIG. 5 is a perspective view of the device of FIG. 1, according to one aspect.

### DETAILED DESCRIPTION OF THE INVENTION

The present invention can be understood more readily by reference to the following detailed description, examples, drawings, and claims, and their previous and following description. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to “a panel” can include two or more such panels unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

This application relates to devices and methods for compacting the fill soil that substantially surrounds a root ball of a plant. In one aspect, a plant packing device 10 comprising a head 12 and a handle 14 is provided, as illustrated in FIGS. 1, 2, and 5. As will be described more fully below, the head can be selectively attachable to the handle, and a user of the device can exert pressure on the handle to compact soil around a plant with at least a portion of a compacting side 18 of the head.

In one aspect, the head 12 can have an attaching side 16 configured for attaching the head to the handle 14 and at least a portion of the opposing compacting side 18 can be configured for exerting a compressive force on a portion of the fill soil 52 above and/or surrounding the root ball 54 of a plant 50, as exemplarily illustrated in FIGS. 2 and 3. In one aspect, it is contemplated that the attaching side 16 can be selectively coupled to the handle 14 or that the attaching side 16 can be fixedly coupled to the handle 14. In a further aspect, it is contemplated that at least a portion of the compacting side 18 of the head can be substantially planar. In another aspect, it is contemplated that the compacting side can be substantially planar. Optionally, it is contemplated the compacting head have a planar shape in which the attaching side 16 and the compacting side 18 are positioned in parallel planes. In yet another aspect, the compacting side 18 of the head can be arcuate in cross-section such that, when in use, at least a portion of the compacting side is configured to compact the soil to be compacted to a different depth. In a further aspect, it is contemplated that the compacting side of the head can be positioned substantially transverse to a longitudinal axis of the handle 14. Optionally, and as illustrated in FIG. 4, the head can be positioned at an obtuse angle A with respect to the longitudinal axis of the handle.

In another aspect, a pair of opposing arms 20 can extend from a front side 22 of the head 12 of the device 10. In use, as will be described more fully below, the pair of opposing arms can be configured to extend and/or wrap around at least a portion of the fill soil positioned above the root ball 54 of the plant 50.

In one aspect, at least a portion of each arm of the pair of arms can be arcuate in shape. For example and without limitation, the front side 22 of the device and the arms 20 can together be substantially C-shaped. In another example and without limitation, the front side of the device and the arms can together be substantially U-shaped. In a further aspect, the arms 20 and the front side of the device can together be substantially the shape of an arcuate section of a circle, oval, ellipse, and the like. In still another aspect, the opposing arms can be minor images of each other, though it is optionally contemplated that a first arm 24 of the pair of arms 20 can be different in shape from a second arm 26 of the pair of arms.

It is also contemplated that each arm of the pair of opposing arms 20 can be substantially linear in shape. In this aspect, the opposing arms can extend outwardly and away from the front side 22 of the head 12 at an acute angle a relative to a longitudinal axis L_{A} of the head. Alternatively, the opposing arms can extend away from the head substantially perpendicularly to the longitudinal axis L_{A} of the head. In other aspects, it is contemplated that portions of each arm can be linear, and portions of each arm can be arcuate.

In one aspect, the head 12 can be sized for compacting the fill soil around differently sized plants. For example, there can be a first head for compacting the soil around a plant having a one gallon container sized root ball, a second head for compacting the soil around a plant having a three gallon container sized root ball, and a third head for compacting the soil around a plant having a five gallon container sized root ball. In one aspect, the compacting side 18 of the head can have a surface area of about 1 inch², about 5 inch², about 10 inch², about 15 inch², about 20 inch², about 25 inch², about 30 inch², about 35 inch², about 40 inch², about 45 inch², about 50 inch², about 60 inch², about 70 inch², about 80 inch², about 90 inch², about 100 inch², about 125 inch², about 1 foot, about 1.5 foot ², about 2 feet², about 2.5 feet², about 3 feet², about 3.5 feet², about 4 feet², or greater than about 4 feet². It is of course contemplated that the head can be sized as small or large as necessary to compact the soil around a variety of plant sizes. Again with reference to FIG. 1, in one aspect, an inner distance D_{I} between the distal ends of each of the arms of the pair of arms 20 can be about 1 inch, about 2 inches, about 3 inches, about 4 inches, about 5 inches, about 6 inches, about 7 inches, about 8 inches, about 9 inches, about 10 inches, about 11 inches, about 1 foot, about 1.25 feet, about 1.5 feet, about 1. 75 feet, about 2 feet, about 2.25 feet, about 2.5 feet, about 2. 75 feet, about 3 feet, or greater than about 3 feet.

In one aspect, a back side 28 of the head 12 of the device 10 can have a plurality of teeth 30 defined therein. In another aspect, the plurality of teeth can be substantially triangular in shape, though other shapes such as substantially square, substantially rectangular, curved, partially curved, and the like are contemplated. In this aspect, the plurality of teeth 30 can be configured for raking fill soil into the hole 52 so that the soil can be compacted around the root ball 54 of the plant 50.

In another aspect, the head 12 of the device 10 can comprise an attachment means for selectively, fixedly attaching the head to the handle 14. In one aspect, a fastener, such as, for example and without limitation, a bolt, screw and the like, can extend from the attaching side 16 of the head. For example, a bore can be defined in the head and the fastener can be positioned in the bore so that a threaded end of the fastener extends from the attaching side of the head. The fastener can be sized and configured for complementary engaging a nut on the handle. Alternatively, in another aspect, a nut can be positioned on the compacting side of or therein the head 12 and co-axially aligned with the bore defined in the head. In this aspect, the nut can be sized and configured for complementary engaging a fastener extending from the handle.

In one aspect, the handle 14 can be an elongate handle. A distal end 32 of the handle can comprise an attachment means for selectively, fixably attaching the handle to the head 12 of the device 10, as described above. For example, a nut can be positioned therein the distal end of the handle for complementary engaging a fastener extending from the head. Alternatively, a fastener, such as, for example and without limitation, a bolt, screw and the like, can extend from the distal end of the handle for complementary engaging a nut positioned on the head 12.

In one aspect, the handle 14 can be about 2 feet in length. In other aspect, the handle can have a length of about 6 inches, about 1 foot, about 1.5 feet, about 2.5 feet, about 3 feet, about 3.5 feet, about 4 feet, about 4.5 feet, about 5 feet, or greater than about 5 feet. In another aspect, the handle 14 can be an adjustable handle configured to be adjusted to a handle length as selected by a user. For example, the handle can telescopically expand from a first, compressed length, to a second expanded length that is greater than the first length. In one aspect, it is contemplated that the handle can be adjusted to any length between about 1 and about 4 feet. In another aspect, the handle can be comprise extension lengths that can be coupled together to extend the handle to a desired length. In still another aspect, it is contemplated that a peg or other surface can extend from the handle 14 to provide a place for the user to place his foot and exert a force onto the handle.

According to one aspect, in order to assemble the plant packing device 10, if a plurality of head sizes are provided, a user can select a desired head 12 based upon the size of the root ball of a predetermined plant to be planted. For example, a small head could be selected if the user is planting a one gallon plant, and a large head could be chosen if the user is planting a five gallon plant. The handle 14 can be fixably attached to the selected head 12 by matingly engaging the fastener of the head or handle to the complementary nut of the respective handle or head. In another aspect, if a plurality of handle lengths are provided, the user can select a desired handle length. Alternatively, if the handle has an adjustable length, the user can adjust the length of the handle to a desired length. As can be appreciated, in use, the user can choose a handle length that does not require the user to bend over. Alternatively, the user can choose a handle length that does not require the user to bend over all the way to the ground.

In order to use the device, after the root ball 54 of a plant 50 has been positioned in a hole 52, the teeth 30 of the device can be used to backfill fill soil above and/or around the root ball. As can be appreciated, the teeth can be used to rake or pull soil towards the hole, and the teeth can be used to push soil towards the hole 52. After a desired amount of soil has been positioned over the root ball 54 of the plant, the compacting side 18 of the head can be placed in contact with the soil to be compacted such that at least a portion of the arms 20 of the head extend over the root ball of the plant. The user can exert a compressive force on the handle 14 (i.e., the user can push the distal end 32 of the handle toward the head 12). If a peg is provided on the handle, the user can exert a compressive force on the handle 14 by pushing his foot against the peg. The compressive force can be transmitted from the handle through the head 12 and the arms 20 of the device 10 to the soil, thereby compacting the soil. In addition to exerting a compressive force on the handle 14, the user can exert a compressive force directly onto the attaching side 16 of the device with a foot or hand. The compressive force can be transmitted through the head and the arms 20 of the device to the soil, thereby compacting the soil. If more soil needs to be compacted, the user can then shift the head to another position around the plant and the user can again exert a compressive force on the handle and/or the head to compact the soil. The user can continue moving the head 12 around the plant 50 until all the soil has been compacted as desired.

As a compressive force is exerted on the head 12 (either directly by the user or indirectly through the handle 14), the force can be spread over the compacting side 18 of the device 10, including the arms 20, so that soil, including soil inaccessible to the hand or foot of the user, can be compacted. As can be appreciated, the compressive force exerted on the handle or the attaching side 16 of the device can be spread over the entire surface area of the compacting side 18. In addition, because the compacting side of the device can have a greater surface area than the hand or foot of a user, more soil can be compacted per compressive action, which reduces the amount of time required to plant the plant 50.

In one aspect, the device 10 can be used to alter an angle formed between the longitudinal axis of the plant 50 and the ground in which it is planted. For example, if the plant is at an acute angle relative to the ground (i.e., the plant is leaning), the plant packer can be used to exert a compressive force on the soil on the side of the plant opposed to the lean, thereby at least partially straightening the plant. In another aspect, the device 10 can be used to compact the soil in a predetermined location relative to the root ball of the plant to alter the angle of the plant relative to the ground.

In one aspect, a kit is provided for planting a plant into the ground. In this aspect, the kit comprises a handle 14, a plant packing head 12 as described above selectively attachable to the handle, and at least one tool selectively attachable to the handle. For example, the at least one tool can comprise at least one of a spade, shovel, hoe, and the like. In use, the shovel can be attached to the handle for digging a hole. Upon completion of the hole, the shovel can be detached from the handle and the plant packing head 12 can be attached to the handle. A plant can be positioned in the hole and the teeth 30 of the plant packing head 12 can be used to backfill fill soil above and/or around the root ball. After a desired amount of soil has been positioned over the root ball of the plant, the compacting side 18 of the head can be placed in contact with the soil to be compacted such that at least a portion of the arms 20 of the head extend over the root ball of the plant. The user can exert a compressive force on the handle 14 or the head 12, thereby compacting the soil.

While reference has been made herein to planting a plant 50 in the ground, it is understood that the device 10 can be equally beneficial when planting a plant in a pot. For example, the head 12 could be used to compact the soil around the root ball of a plant positioned in a pot so that a user could efficiently compact the soil in the pot without bending over and/or touching the soil with the user's hands.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed hereinabove, and that many modifications and other embodiments are intended to be included within the scope of the appended claims. Moreover, although specific terms are employed herein, as well as in the claims which follow, they are used only in a generic and descriptive sense, and not for the purposes of limiting the described invention, nor the claims which follow.

What is claimed is:

1. A device for exerting a compressive force on the soil around a plant comprising
an elongate handle; and
a head coupled to the elongate handle, wherein the head comprises an attaching side for attaching the head to the handle and an opposed compacting side configured for exerting a compressive force on a portion of the soil around the plant, and wherein the head further comprises a front side and a pair of opposing arms extending outwardly from the front side of the head.

2. The device of claim 1, wherein at least a portion of each arm of the pair of opposing arms is arcuate in shape.

3. The device of claim 2, wherein the front side of the device and the pair of opposing arms together are substantially C-shaped.

4. The device of claim 2, wherein the front side of the device and the pair of opposing arms together are the shape of an arcuate section of an oval.

5. The device of claim 1, wherein each arm of the pair of opposing arms is substantially linear in shape.

6. The device of claim 1, wherein each arm of the pair of opposing arms extends outwardly and away from the front side of the head at an acute angle relative to a longitudinal axis of the head.

7. The device of claim 1, wherein portions of each arm of the pair of opposing arms are linear and portions of each arm are arcuate.

8. The device of claim 1, wherein the head further comprises a back side opposed to the front side, and wherein the back side defines a plurality of teeth.

9. The device of claim 8, wherein the plurality of teeth are substantially triangular in shape.

10. The device of claim 1, wherein the head is selectively attachable to the handle.

11. The device of claim 1, wherein the elongate handle comprises an adjustable handle configured to be adjusted to a predetermined handle length.

12. The device of claim 1, wherein the elongate handle is substantially perpendicular to the compacting side of the head.

13. The device of claim 1, wherein the elongate handle is positioned at an acute angle relative to the compacting side of the head.

14. The device of claim 1, wherein the compacting side of the head is substantially planar.

15. A method for exerting a compressive force on the soil around a plant after a root ball of the plant has been positioned in a hole, comprising:
providing a device comprising:
an elongate handle; and
a head coupled to the elongate handle, wherein the head comprises a front side and an opposed back side, an attaching side for attaching the head to the handle and an opposed compacting side configured for exerting a compressive force on a portion of the soil around the plant, wherein a pair of opposing arms extend outwardly from the front side of the head, and wherein the back side defines a plurality of teeth;
raking fill soil into the hole with the plurality of teeth until the root ball is covered with fill soil;
placing the compacting side of the head in contact with the fill soil; and
exerting a compressive force on the device so that the soil can be compacted around root ball of the plant.

16. The method of claim 15, wherein exerting a compressive force on the device comprises exerting a compressive force on the handle of the device.

17. The method of claim 15, wherein placing the compacting side of the head in contact with the fill soil comprises positioning the head so that at least a portion of the plant is positioned between the pair of opposing arms and the pair of opposing arms are in contact with fill soil above the root ball of the plant.

18. A device for exerting a compressive force on the soil around a plant after a root ball of the plant has been positioned in a hole comprising
an elongate handle; and
a head coupled to the elongate handle, wherein the head comprises an attaching side for attaching the head to the handle, and an opposed compacting side configured for exerting a compressive force on a portion of the soil around the plant, wherein the head further comprises a front side and a pair of opposing arms extending outwardly from the front side of the head, and wherein the compacting side of the device has a surface area of at least about 1 inch²; and
means for raking fill soil into the hole.

19. The device of claim 18, wherein the compacting side of the device has a surface area between about 1 inch² to about 4 feet.

20. The device of claim 19, wherein each arm of the pair of opposing arms has a distal end, and wherein the inner distance between the distal ends of the pair of opposing arms can be spaced between about 1 inch to about 3 feet.
